(19) United States
(12) Patent Application Publication
(10) Pub. No.: US 2005/0018297 A1
(43) Pub. Date: Jan. 27, 2005

(54) Optical component and optical pickup apparatus

(75) Inventors: Tatsuo Ohta, Tokyo (JP); Norikazu Arai, Tokyo (JP); Shin-ichiro Saito, Tokyo (JP)

Correspondence Address: Finnegan, Henderson, Farabow,;Garrett & Dunner, L.L.P., 1300 I Street, N.W., Washington, DC, 20005-3315, US

(73) Assignee: KONICA MINOLTA OPTO, INC.

(21) Appl. No.: 10/886,625

(22) Filed: Jul. 9, 2004

(30) Foreign Application Priority Data
Jul. 10, 2003 (JP) 2003-194744
Sep. 17, 2003 (JP) 2003-323955

(51) Int. Cl. G02B 5/18; G02B 27/44

(52) U.S. Cl. 359/566

(57) ABSTRACT

This invention provides an optical component which can keep the light transmittance high while ensuring good wiping resistance characteristics, and can also realize intended optical characteristics based on a fine structure, and an optical pickup apparatus including the optical component. An optical component according to this invention includes a first optical surface on which a fine structure is formed and a second optical surface on which no fine structure is formed. The number of layers of an antireflection film on the first optical surface is set to be smaller than the number of layers of an antireflection film on the second optical surface.

### BACKGROUND OF THE INVENTION

1. Field of the Invention

The present invention relates to an optical component and optical pickup apparatus and, more particularly, to an optical component and optical pickup apparatus which improve optical performance.

2. Description of the Prior Art

Recently, as short-wavelength red semiconductor lasers have been put into practice, DVDs (Digital Versatile Disks) have been commercially available, which are high-density optical disks almost equal in size to CDs (Compact Disks) as conventional optical disks (also called optical information recording media) and having large capacities. However, an optical pickup apparatus designed to record/reproduce information on/from CDs or DVDs alone are not sufficient in terms of the value of products. For this reason, in order to increase the added value, a so-called compatible optical pickup apparatus which can record/reproduce information on/from both CDs and DVDs has also been developed.

CDs and DVDs differ in specifications (light source wavelength, numerical aperture, transparent substrate thickness, and the like). In order to properly record and/or reproduce information on/from both types of optical disks by using a single objective lens, therefore, some implementation is needed. In order to meet this need, a diffraction structure is provided on an optical surface of an objective lens so as to obtain aberration characteristics suitable for CDs and DVDs.

Meanwhile, there has been developed a next-generation high-density optical disk, one step advanced from CDs and DVDs. A condensing optical system for an optical information recording/reproducing apparatus (to be also referred to as an optical pickup apparatus) using such a next-generation optical disk as a medium is required to decrease the diameter of a spot condensed onto an information recording surface through an objective lens so as to record recording signals at a higher density or reproduce high-density recording signals. In order to realize this, it is necessary to shorten the wavelength of a laser serving as a light source or increase the numerical aperture (NA) of the objective lens. A blue-violet semiconductor laser having a wavelength of 450 nm or less is expected to be commercialized as a short-wavelength laser light source.

Research and development on a high-density optical disk system have rapidly progressed, which can record/reproduce information by using such a blue-violet semiconductor laser light source having a wavelength of 450 nm or less. For example, an optical disk designed to record/reproduce information under specifications of an NA of 0.85 and a light source wavelength of 405 nm (such an optical disk will be referred to as a “high-density DVD” hereinafter in this specification) can record information of 20 to 30 GB per surface with a diameter of 12 cm, which is equal to that of a DVD (NA=0.6, light source wavelength=650 nm, and storage capacity=4.7 GB). An objective lens which has a diffraction structure to form an appropriate condensed light spot on the information recording surface of such a high-density DVD has also been developed (see patent reference 1: Japanese Unexamined Patent Publication No. 2002-236253).

An optical component of an optical pickup apparatus has been contrived to increase its transmittance so as to efficiently use the laser beam emitted from a light source. For example, an antireflection film is formed on an optical surface of an objective lens or the like to suppress the amount of light reflected by the optical surface by using interference of light (see patent reference 2: Japanese Unexamined Patent Publication No. 2002-55207).

When, however, an antireflection film is to be formed on an objective lens used for a compatible optical pickup apparatus like that described above, an antireflection effect must be realized for each of light beams of different wavelengths incident on the film. In general, the thickness of an antireflection film needs to be increased to ensure a wide wavelength range in which an antireflection effect can be realized. However, an increase in film thickness makes the shape (the shape of a corner portion, in particular) of the above diffraction structure dull. This may make it impossible to obtain desired diffraction characteristics.

In addition, in order to obtain a diffraction effect in a short wavelength region of 450 nm or less, a smaller diffraction structure is required. Therefore, an antireflection film has a greater influence on the shape of the diffraction structure. This makes it difficult to obtain required diffraction characteristics for an objective lens used for an optical pickup apparatus for high-density DVDs, in particular.

In addition, an optical component on which an antireflection film is formed is required to have good so-called wiping properties, i.e., suppressing peeling of the antireflection film by wiping out foreign substances adhering to an optical surface. However, forming a thick antireflection film on a diffraction structure considerably degrades the wiping properties.

### SUMMARY OF THE INVENTION

The present invention has been made in consideration of the above problems, and has as its object to provide an optical component and optical pickup apparatus which can keep the light transmittance high while ensuring high wiping resistance, and can also realize intended optical characteristics based on a fine structure.

In order to achieve the above object, according to the first aspect of the present invention, there is provided an optical component comprising: a first optical surface having a fine structure; a second optical surface without having the fine structure; a first antireflection film provided on the first optical surface, in which the first antireflection film includes at least one layer; and a second antireflection film provided on the second optical surface, in which the second antireflection film includes a plurality of layers, wherein the number of layers of the first antireflection film is less than the number of layers of the second antireflection film.

With this arrangement, for example, since the number of layers of the antireflection film on the first optical surface on which the fine structure such as a diffraction structure is formed is relatively small, the thickness of the antireflection film can be made relatively thin. This makes it easy to maintain the shape of the fine structure after film formation, and makes it possible to prevent a deterioration in the optical characteristics of the fine structure. In addition, the wiping characteristics can be improved. On the other hand, since no fine structure is formed on the second optical surface, even increasing the thickness of the antireflection film causes no deterioration in optical characteristics and no deterioration in wiping characteristics. Therefore, a sufficient antireflection function can be realized by increasing the number of layers of an antireflection film.

According to the second aspect of the present invention, there is provided an optical component wherein the fine structure in the first aspect is a ring-like phase-difference-generating structure.

According to the third aspect of the present invention, in the optical component described in the first or second aspect, the second antireflection film consists of seven layers.

According to the fourth aspect of the present invention, in the optical component described in the first or second aspect, the second antireflection film consists of eight layers to ten layers.

According to the fifth aspect of the present invention, in the optical component described in any one of the first to fourth aspects, the first antireflection film consists of one layer.

According to the sixth aspect of the present invention, in the optical component described in any one of the first to fourth aspects, the first antireflection film consists of two layers.

According to the seventh aspect of the present invention, in the optical component described in any one of the first to fourth aspects, the first antireflection film consists of three layers.

According to the eighth aspect of the present invention, in the optical component described in any one of the first to fourth aspects, the first antireflection film consists of four layers to nine layers.

According to the ninth aspect of the present invention, there is provided an optical component comprising: a first optical surface having a fine structure; a second optical surface without having the fine structure; and an antireflection film provided only on the second optical surface.

With this arrangement, even forming an antireflection film does not change the fine structure on the first optical surface, thereby preventing a deterioration in its optical characteristics and improving the wiping characteristics.

According to the 10th aspect of the present invention, in the optical component described in the ninth aspect, the fine structure described in the ninth aspect is a ring-like phase-difference-generating structure.

According to the 11th aspect of the present invention, in the optical component described in the ninth or 10th aspect, the antireflection film consists of seven layers.

According to the 12th aspect of the present invention, in the optical component described in the ninth or 10th aspect, the antireflection film consists of eight layers to ten layers.

According to the 13th aspect of the present invention, in the optical component described in any one of the first to eighth aspects, the optical component is an objective lens for an optical pickup apparatus.

With this arrangement, the performance of the optical pickup apparatus can be improved. However, the optical component of the present invention is not limited to an objective lens and may include a coupling lens, expander lens, parallel plate, and the like.

According to the 14th aspect of the present invention, in the optical component described in the ninth to 12th aspects, the optical component is an objective lens for an optical pickup apparatus.

According to the 15th aspect of the present invention, in the optical component described in the 13th aspect, the objective lens is used for a so-called compatible optical pickup apparatus which is capable of condensing each of light beams of different wavelengths emitted from a plurality of light sources mounted in the optical pickup apparatus, onto an information recording surface of optical information recording media corresponding to each of the light beams.

According to the 16th aspect of the present invention, in the optical component described in the 14th aspect, the objective lens is used for a so-called compatible optical pickup apparatus which is capable of condensing each of light beams of different wavelengths emitted from a plurality of light sources mounted in the optical pickup apparatus, onto an information recording surface of optical information recording media corresponding to each of the light beams.

According to the 17th aspect of the present invention, in the optical component described in the 13th or 15th aspect, the objective lens is used for an optical pickup apparatus for so-called high-density DVDs, which is capable of condensing a light beam of a wavelength λ (λ≦450 nm) onto an information recording surface of an optical information recording medium.

According to the 18th aspect of the present invention, in the optical component described in the 14th or 16th aspect, the objective lens is used for an optical pickup apparatus for so-called high-density DVDs, which is capable of condensing a light beam of a wavelength λ (λ≦450 nm) onto an information recording surface of an optical information recording medium.

According to the 19th aspect of the present invention, there is provided an optical component for use in an optical pickup apparatus, comprising: a plurality of optical surfaces; a first antireflection film provided on one optical surface of the optical surfaces, in which the first antireflection film includes at least one layer; and a second antireflection film provided on the other optical surface of the optical surface, in which the second antireflection film includes a plurality of layers, wherein the optical component is arranged on an optical path through which a first light beam of a wavelength λ1 (390 nm≦λ1≦450 nm) passes, and at least one of a second light beam of a wavelength λ2 (635 nm≦λ2≦670 nm) and a third light beam of a wavelength λ3 (740 nm≦λ3≦810 nm) passes in the optical pickup apparatus, and the following conditional formula is satisfied: m1<m2 where m1 is the number of layers of the first antireflection film, and m2 is the number of layers of the second antireflection film.

With this arrangement, when a phase-difference-generating structure is to be formed on one optical surface of an optical component used for an optical pickup apparatus which compatibly records and/or reproduces information on/from a high-density DVD and either one of optical disks such as, for example, DVD and CD, or a high-density DVD and both of optical disks such as, for example, DVD and CD, the loss of light on the optical surface can be reduced and its wiping characteristics can be improved by setting a small number of layers for an antireflection film on the optical surface on which the phase-difference-generating structure is provided.

As an optical pickup apparatus which compatibly records and/or reproduces information, there is known an optical pickup apparatus which can record and/or reproduce information on/from a high-density DVD having a protective layer thickness of 0.6 mm by using a blue-violet semiconductor laser, and can record and/or reproduce information on/from a DVD and/or a CD by using a red semiconductor laser, or an optical pickup apparatus which can record and/or reproduce information on/from a high-density DVD having a protective layer thickness of 0.1 mm by using a blue-violet semiconductor laser, and can record and/or reproduce information on/from a DVD and/or a CD by using a red semiconductor laser. The present invention can also be applied to a case wherein the optical component is comprised of two objective lenses in such an optical pickup apparatus. More specifically, the adverse effects produced as the number of layers of an antireflection film increases can be suppressed by setting the number of layers (m1) of an antireflection film provided on one of the four optical surfaces of the two objective lenses which has a phase different adding function or an acute convex shape to be smaller than that (m2) on each remaining optical surfaces having a less acute convex shape.

According to the 20th aspect of the present invention, in the optical component described in the 19th aspect, a phase-difference-generating structure is formed on the one optical surface. Note, however, that the one optical surface is not limited to the optical surface having the phase-difference-generating structure, and may be an optical surface having an acuter convex shape (a smaller radius of curvature) than the remaining optical surface.

According to the 21st aspect of the present invention, in the optical component described in the 19th or 20th aspect, wherein the following conditional formula is satisfied: Φ1 >Φ2 where Φ1 is an effective diameter of the one optical surface when the first light beam passes through the optical component, and Φ2 is an effective diameter of the other optical surface when the first light beam passes through the optical component.

With this arrangement, when the optical pickup apparatus which compatibly records and/or reproduces information is used for a high-density DVD and either one of optical disks such as, for example, DVD and CD, or a high-density DVD and both of optical disks such as, for example, DVD and CD, it becomes possible to record and/or reproduce information on/from a plurality of optical disks.

According to the 22nd aspect of the present invention, in the optical component described in any one of the 19th to 21st aspects, the number of layers m2 is seven.

According to the 23rd aspect of the present invention, in the optical component described in any one of the 19th to 21st aspects, the number of layers m2 is eight to ten.

According to the 24th aspect of the present invention, there is provided an optical pickup apparatus comprising a light source and a condensing optical system including the optical component of the first to eighth aspects, wherein the optical component is capable of condensing a light beam from a light source onto an information recording surface of an optical information recording medium.

According to the 25th aspect of the present invention, there is provided an optical pickup apparatus comprising a light source and a condensing optical system including the optical component of the ninth to 18th aspects, wherein the optical component is capable of condensing a light beam from a light source onto an information recording surface of an optical information recording medium.

According to the 26th aspect of the present invention, there is provided an optical pickup apparatus comprising a plurality of light sources and a condensing optical system including the optical component of the 19th to 23rd aspects, wherein the optical component is capable of condensing each of light beams from the light sources onto information recording surfaces of optical information recording media corresponding to each of the light beams, respectively.

The term “fine structure” used in this specification indicates a structure having such a function as generating an optical path difference. A stepped configuration for generating an optical path difference or a phase-difference-generating structure, etc., is an example of the optical path-difference-generating structure.

In addition, the term “phase-difference-generating structure” used in this specification indicates a structure which can realize a phase-difference-generating function, and the phase-difference-generating function indicates a function of applying a special effect to an incident light beam by generating a predetermined phase difference to the light beam. For example, a “diffraction structure” is an example of this phase-difference-generating structure.

Further, the term “diffraction structure” indicates a portion of a surface of an optical component on which a relief is provided to condense or diverge a light beam by using diffraction. As such a relief shape, there is known a shape obtained by forming concentric rings, centered on an optical axis, on a surface of an optical component with each ring having a serrated or staircase-like cross section when viewed from a plane including the optical axis. The above relief shape includes such a shape, which is referred to as a “diffraction ring”, in particular.

In this specification, an objective lens indicates, in a narrow sense, a lens with a condensing effect which is placed nearest to the optical information recording medium side to oppose it in a state wherein the optical information recording medium is loaded in an optical pickup apparatus, and indicates, in a broad sense, a lens which can be moved in at least the optical axis direction by an actuator, in addition to the above lens.

As is obvious from the respective aspects described above, according to the present invention, an optical component and optical pickup apparatus can be provided, which can maintain high light transmittance while ensuring high wiping resistance, and can also realize intended optical characteristics based on, for example, a fine structure.

The above and many other objects, features and advantages of the present invention will become manifest to those skilled in the art upon making reference to the following detailed description and accompanying drawings in which preferred embodiment incorporating the principle of the present invention are shown by way of illustrative examples.

### BRIEF DESCRIPTION OF THE DRAWINGS

FIG. 1 is a schematic view showing the arrangement of an optical pickup apparatus according to the first embodiment;

FIG. 2 is a schematic view showing the arrangement of an optical pickup apparatus according to the second embodiment;

FIG. 3 is a sectional view of an objective lens; and

FIG. 4 is a sectional view of another objective lens.

### DETAILED DESCRIPTION OF THE PREFERRED EMBODIMENTS

A few preferred embodiments of the present invention will be described in detail below with reference to the accompanying drawings.

(First Embodiment)

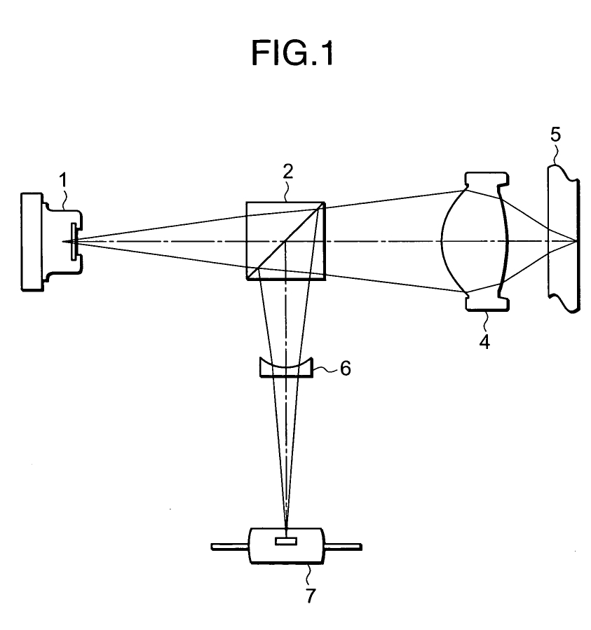

The first embodiment will be described. FIG. 1 is a schematic view showing the arrangement of an optical pickup apparatus according to the first embodiment. Referring to FIG. 1, a light beam (wavelength: 390 to 450 nm) from a semiconductor laser as a light source passes through a beam splitter 2 and strikes an objective lens 4 forming a diffraction structure on a light-source-side surface (first optical surface). A light beam emerging from a medium-side surface (second optical surface) of the objective lens 4 on which no diffraction structure is formed is condensed onto the information recording surface of an optical information recording medium 5 which is a high-density DVD. Light reflected by the optical information recording medium 5 passes through the objective lens 4 and is reflected by the beam splitter 2 in a direction different from the semiconductor laser 1. After astigmatism is generated by an astigmatism generating lens 6, this light is received by a photodetector 7. Note that although not shown, this apparatus includes a focusing mechanism which integrally moves the objective lens in the optical axis direction (ditto for the second embodiment to be described below).

(Second Embodiment)

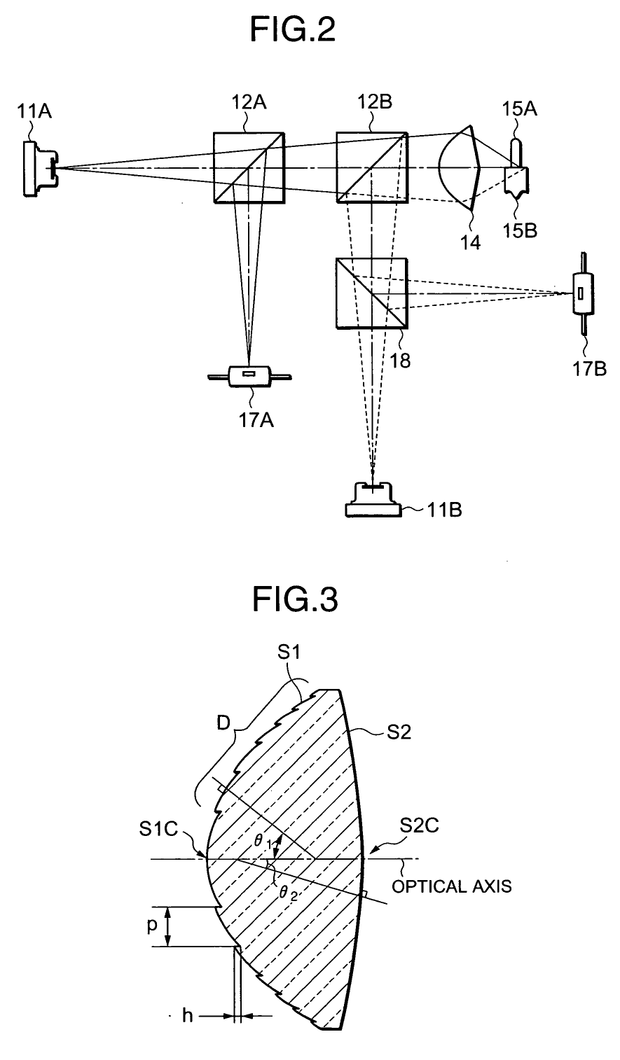

The second embodiment will be described below. FIG. 2 is a schematic view showing the arrangement of an optical pickup apparatus according to the second embodiment. Referring to FIG. 2, a light beam (wavelength: 635 nm to 670 nm) from a first semiconductor laser 11A as a first light source passes through beam splitters 12A and 12B and strikes an objective lens 14 forming a diffraction structure on a light-source-side surface (first optical surface). A light beam emerging from a medium-side surface (second optical surface) of the objective lens 14 on which no diffraction structure is formed is condensed on the information recording surface of a first optical information recording medium 15A (DVD in this case). Light reflected by the first optical information recording medium 15A passes through the beam splitter 12B and is reflected by the beam splitter 12A in a direction different from the first semiconductor laser 11A. The reflected light is then received by a photodetector 17A.

In contrast to this, referring to FIG. 2, a light beam (wavelength: 390 nm to 450 nm) from a second semiconductor laser 11B as a second light source passes through a beam splitter 18 and is reflected by the beam splitter 12B. The reflected light beam is incident on the objective lens 14 forming a diffraction structure on the light-source-side surface (first optical surface). A light beam emerging from the medium-side surface (second optical surface) of the objective lens 14 on which no diffraction structure is formed is condensed onto the information recording surface of a second optical information recording medium 15B (CD in this case, but the high-density DVD is preferable). Meanwhile, light reflected by the second optical information recording medium 15B passes through the objective lens 14 and is reflected by the beam splitters 12B and 18. The reflected light beam is received by a photodetector 17B. Note that so-called two lasers in one package as a light source can be obtained by forming the first semiconductor lasers 11A and 11B into one unit on the same substrate. Likewise, in addition to light beams of the above two types of wavelengths, a light source of another type of wavelength (wavelength: 740 to 810 nm), i.e., a total of three types of light beams, may pass through the objective lens 14.

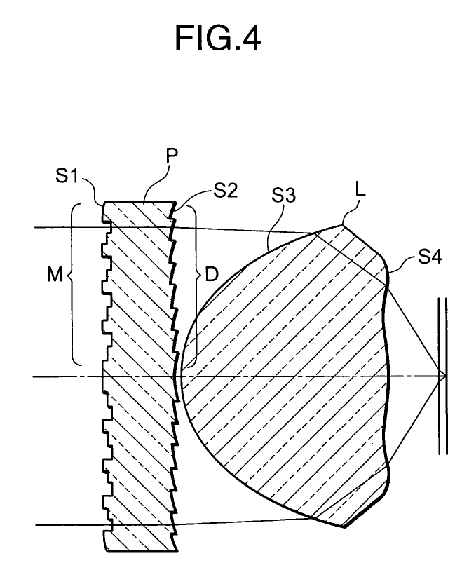

FIG. 3 is a sectional view showing an example of an objective lens which can be used for an optical pickup apparatus using any one of the combinations of the three types of light beams in FIGS. 1 and 2. For the sake of easy understanding, FIG. 3 shows an exaggerated view of the diffraction structure D. Referring to FIG. 3, the objective lens has the diffraction structure D which has a ring-like shape with a serrated cross section centered on the optical axis and is formed on only a first optical surface S1. No diffraction structure is therefore formed on a second optical surface S2. Obviously, the first optical surface may be set on the light source side, and the second optical surface may be set on the medium side.

A ring pitch p of the diffraction structure D (in a direction perpendicular to the optical axis) is 10 to 100 μm, and a groove depth (a difference in level in the optical axis direction) h of the diffraction structure D is several μm.

FIG. 4 is a sectional view showing an example of an objective lens which can be used for an optical pickup apparatus using any one of the combinations of two to three types of light beams in FIG. 2. In the second embodiment, the objective lens is comprised of two elements. More specifically, the objective lens is comprised of a plate-like element P on the light source side (the left side in FIG. 4) and a lens L on the optical disk side (the right side in FIG. 4). A phase-difference-generating structure M is formed on an optical surface S1 of the plate-like element P which is located on the light source side by shifting its surface in a ring form in the optical axis direction. A phase-difference-generating structure D having a diffraction structure with a serrated cross section in the optical axis direction is formed on an optical surface S2 of the ring pitch p which is located on the optical disk side. An optical surface S3 of the lens L which is located on the light source side and an optical surface S4 of the lens L which is located on the optical disk side have aspherical shapes and no phase diffraction structure. The following are the number of layers of antireflection films on the respective optical surfaces and their effective diameters:

(The number of layers m1 on S1 (optical surface), the number of layers m1 on S2, the number of layers m2 on S3, the number of layers m2 on S4)=(7, 5, 7, 7), (5, 7, 7, 7), (7, 7, 5, 7), (5, 5, 8, 10), (7, 7, 10, 9), or (8, 8, 10, 10)

Effective diameter (Φ1) of S1 at the time of passage of light beam from second semiconductor laser 11B: 3.7 mm

Effective diameter (Φ1) of S2 at the time of passage of light beam from second semiconductor laser 11B: 3.7 mm

Effective diameter (Φ2) of S3 at the time of passage of light beam from second semiconductor laser 11B: 3.6 mm

Effective diameter (Φ2) of S4 at the time of passage of light beam from second semiconductor laser 11B: 2.3 mm

Note that the above values are merely examples, and the present invention is not limited to them.

### EXPERIMENTAL EXAMPLE

A film formation experiment on a plurality of antireflection films was conducted by stacking layers made of materials of different reflectances on the objective lens in FIG. 3.

Table 1 shows the thicknesses of one-layer films to 10-layer films respectively designed for a case where the wavelength of transmitted light is 390 to 450 nm and a case where the wavelength of transmitted light is 635 to 670 nm. In addition to the cases of these two types of wavelengths, Table 1 shows the thicknesses of a one-layer film to a 10-layer film designed for a case where the wavelength of transmitted light is 740 to 810 nm.

TABLE 1
(Table 1-1)

| | (1) | (2) | (3) | (4) | (5) |
|---|---|---|---|---|---|
| | One-layer | Two-layer | Two-layer | Three-layer | Four-layer |
| | Arrangement | Arrangement | Arrangement | Arrangement | Arrangement |
| 7 | | | | | |
| 6 | | | | | |
| 5 | | | | | |
| 4 | | | | | L material |
| | | | | | T₄ = 0.2˜0.3 |
| 3 | | | | L material | H material |
| | | | | T₃ = 0.2˜0.3 | T₃ = 0.2˜0.3 |
| 2 | | L material | L material | H material | H material |
| | | T₂ = 0.2˜0.33 | T₂ = 0.2˜0.3 | T₂ = 0.4˜0.6 | T₂ = 0.2˜0.3 |
| First Layer | L material | H or M | H or M | L material | L material |
| | T₁ = 0.2˜0.3 | material | material | T₁ = 0.2˜0.3 | T₁ = 0.4˜0.6 |
| | | T₁ = 0.02˜0.12 | T₁ = 0.04˜0.6 | | |
| Base Material | plastic or | plastic or | plastic or | plastic or | plastic or |
| | glass | glass | glass | glass | glass |

(Table 1-2)

| | (6) | (7) | (8) | (9) | (10) |
|---|---|---|---|---|---|
| | Four-layer | Five-layer | Five-layer | Six-layer | Seven-layer |
| | Arrangement | Arrangement | Arrangement | Arrangement | Arrangement |
| 7 | | | | | L material |
| | | | | | T₇ = 0.27˜0.31 |
| 6 | | | | L material | H material |
| | | | | T₆ = 0.21˜0.28 | T₆ = 0.14˜0.18 |
| 5 | | L material | L material | H material | L material |
| | | T₅ = 0.2˜0.3 | T₅ = 0.21˜0.28 | T₅ = 0.48˜0.52 | T₅ = 0.04˜0.07 |
| 4 | L material | H material | H material | M material | H material |
| | T₄ = 0.2˜0.3 | T₄ = 0.4˜0.5 | T₄ = 0.48˜0.52 | T₄ = 0.31˜0.34 | T₄ = 0.15˜0.30 |
| 3 | H material | L material | M material | L material | L material |
| | T₃ = 0.4˜0.6 | T₃ = 0.07˜0.1 | T₃ = 0.31˜0.34 | T₃ = 0.10˜0.13 | T₃ = 0.08˜0.10 |
| 2 | L material | H material | L material | M material | H material |
| | T₂ = 0.2˜0.3 | T₂ = 0.03˜0.06 | T₂ = 0.10˜0.13 | T₂ = 0.09˜0.11 | T₂ = 0.06˜0.08 |
| First | L material | L material | M material | L material | L material |
| Layer | T₁ = 0.2˜0.3 | T₁ = 0.3˜0.6 | T₁ = 0.09˜0.11 | T₁ = 0.01˜0.6 | T₁ = 0.04˜0.07 |
| Base | plastic or | plastic or | plastic or | plastic or | plastic or |
| Mate- | glass | glass | glass | glass | glass |
| rial | | | | | |

(Table 1-3)

| | (11) | (12) | (13) | (14) |
|---|---|---|---|---|
| | Seven-layer | Eight-layer | Nine-layer | 10-layer |
| | Arrangement | Arrangement | Arrangement | Arrangement |
| 10 | | | | L material |
| | | | | T₁₀ = 0.25˜0.29 |
| 9 | | | L material | H material |
| | | | T₉ = 0.20˜0.24 | T₉ = 0.12˜0.16 |
| 8 | | L material | H material | L material |
| | | T₈ = 0.20˜0.24 | T₈ = 0.41˜0.46 | T₈ = 0.03˜0.06 |
| 7 | L material | H material | L material | H material |
| | T₇ = | T₇ = 0.41˜0.46 | T₇ = 0.40˜0.45 | T₇ = 0.25˜0.29 |
| | 0.29˜0.33 | | | |
| 6 | H material | L material | H material | L material |
| | T₆ = | T₆ = 0.40˜0.45 | T₆ = 0.07˜0.11 | T₆ = 0.49˜0.55 |
| | 0.20˜0.24 | | | |
| 5 | L material | H material | L material | H material |
| | T₅ = | T₅ = 0.07˜0.11 | T₅ = 0.02˜0.06 | T₅ = 0.06˜0.10 |
| | 0.03˜0.07 | | | |
| 4 | H material | L material | H material | L material |
| | T₄ = | T₄ = 0.02˜0.06 | T₄ = 0.36˜0.42 | T₄ = 0.10˜0.14 |
| | 0.24˜0.29 | | | |
| 3 | L material | H material | L material | H material |
| | T₃ = | T₃ = 0.36˜0.42 | T₃ = 0.05˜0.08 | T₃ = 0.18˜0.22 |
| | 0.10˜0.15 | | | |
| 2 | H material | L material | H material | L material |
| | T₂ = | T₂ = 0.05˜0.08 | T₂ = 0.04˜0.07 | T₂ = 0.04˜0.08 |
| | 0.06˜0.09 | | | |
| First | L material | H material | L material | H material |
| Layer | T₁ = | T₁ = 0.04˜0.07 | T₁ = 0.1˜0.35 | T₁ = 0.08˜0.12 |
| | 0.35˜0.39 | | | |
| Base | plastic or | plastic or | plastic or | plastic or |
| Mate- | glass | glass | glass | glass |
| rial | | | | |

The thickness of each layer is the thickness at the positions of lens central portions S1C and S2C (see FIG. 3).

Note that the film thickness of a given layer can be obtained by
Ti=nidi/λ₀
where
Ti: film thickness of i^{th} layer (optical film thickness)
ni: refractive index of i^{th} layer
di: geometrical film thickness of i^{th} layer (nm)
λ₀: design wavelength (nm)

The following were used as materials for film formation
(1) low-refractive-index material (L material): aluminum fluoride, magnesium fluoride, or silicon oxide: refractive index of 1.30 to 1.50
(2) medium-refractive-index material (M material): aluminum oxide, yttrium oxide, or cerium oxide: refractive index of 1.55 to 1.70
(3) high-refractive-index material (H material): zirconium oxide, tantalum oxide, titanium oxide, or hafnium oxide: refractive index of 1.75 to 2.50

Each optical surface of an objective lens was coated with one of the above materials alone or a mixed material containing it as a main component.

A material (base material) making an objective lens as an optical component includes acrylic resin and polycarbonate resin. More specifically, a transparent plastic resin such as ZEONEX (trade name; available from ZEON CORPORATION) or a glass material is used. A plastic resin to be used is not limited to the above resins and includes all kinds of resins suitable as materials for the optical component.

In addition, an underlayer may be provided between the base material and the first layer to improve the durability of the film. A lens surface is used facing an optical information recording medium, e.g., S2 of the lens shape shown in FIG. 3 or S4 of the lens shape shown in FIG. 4, is required to have high abrasion resistance. For this reason, an underlayer formed from a silicon oxide film having a thickness of 0.1μ to 10μ is sometimes provided for such a lens surface.

Coating methods include a vacuum deposition method, sputtering method, CVD method, atmospheric plasma method, application method, mist method, and the like. In this example, the vacuum deposition method was used.

### EXPERIMENTAL EXAMPLE 1

No antireflection coating was formed on S1 of the objective lens made of Zeonex resin in the shape shown in FIG. 3 through which two types of light beams of wavelengths of 405 nm and 650 nm pass, and a 7-layer antireflection coating having the thickness indicated by (10) in Table 1 was formed on S2. With regard to the arrangement of the respective layers on S2, the layer nearest to the material surface of the objective lens is regarded as the first layer, and the layer farthest from the material surface is regarded as the seventh layer. All the following layers are counted in the same manner.

Table 2 shows the specifications of the seven layers on S2.

TABLE 2

| | | | | | More |
|---|---|---|---|---|---|
| | | | Design | | Preferable |
| | | Refractive | Wavelength | Thickness | Thickness |
| | Material | Index | (nm) | (nm) | (nm) |
| First | silicon | 1.45-1.47 | 480 | 18-19 | 18.5 |
| Layer | oxide | | | | |
| Second | mixed | 1.95-2.01 | 480 | 17-18 | 17.5 |
| Layer | material | | | | |
| | of | | | | |
| | tantalum | | | | |
| | oxide and | | | | |
| | titanium | | | | |
| Third | silicon | 1.45-2.01 | 480 | 29-31 | 30.0 |
| Layer | oxide | | | | |
| Fourth | mixed | 1.95-2.01 | 480 | 55-57 | 56.2 |
| Layer | material | | | | |
| | of | | | | |
| | tantalum | | | | |
| | oxide and | | | | |
| | titanium | | | | |
| Fifth | silicon | 1.45-1.47 | 480 | 19-20 | 19.3 |
| Layer | oxide | | | | |
| Sixth | mixed | 1.95-2.01 | 480 | 36-38 | 36.8 |
| Layer | material | | | | |
| | of | | | | |
| | tantalum | | | | |
| | oxide and | | | | |
| | titanium | | | | |
| Seventh | silicon | 1.45-1.47 | 480 | 96-98 | 97.2 |
| Layer | oxide | | | | |

As a mixed material of tantalum oxide and titanium, OA600 (trade name; available from K.K. Optron) was used.

### EXPERIMENTAL EXAMPLE 2

A one-layer antireflection coating having the thickness indicated in (1) in Table 1 was formed on S1 of an objective lens identical to the one in Experimental Example 1, and a 7-layer antireflection coating having the thickness indicated in (10) in Table 1 was formed on S2.

Table 3 shows the specifications of the one layer on S1. Table 4 shows the specifications of the seven layers on S2.

TABLE 3

| | | | | More |
|---|---|---|---|---|
| | | Design | | Preferable |
| | Refractive | Wavelength | Thickness | Thickness |
| Material | Index | (nm) | (nm) | (nm) |
| magnesium | 1.35-1.38 | 540 | 95-110 | 97.6 |
| fluoride | | | | |

TABLE 4

| | | | | | More |
|---|---|---|---|---|---|
| | | | Design | | Preferable |
| | | Refractive | Wavelength | Thickness | Thickness |
| | Material | Index | (nm) | (nm) | (nm) |
| First | silicon | 1.45-1.47 | 480 | 17-19 | 18.2 |
| Layer | oxide | | | | |
| Second | mixed | 1.94-2.02 | 480 | 16.5-18 | 17.2 |
| Layer | material | | | | |
| | of | | | | |
| | zirconium | | | | |
| | oxide and | | | | |
| | Ti | | | | |
| Third | silicon | 1.45-1.47 | 480 | 29.1-31.3 | 30.1 |
| Layer | oxide | | | | |
| Fourth | mixed | 1.94-2.02 | 480 | 54.8-57.1 | 55.3 |
| Layer | material | | | | |
| | of | | | | |
| | zirconium | | | | |
| | oxide and | | | | |
| | Ti | | | | |
| Fifth | silicon | 1.45-1.47 | 480 | 19.1-20 | 19.3 |
| Layer | oxide | | | | |
| Sixth | mixed | 1.94-2.02 | 480 | 35.8-38.2 | 36.8 |
| Layer | material | | | | |
| | of | | | | |
| | zirconium | | | | |
| | oxide and | | | | |
| | Ti | | | | |
| Seventh | silicon | 1.45-1.47 | 480 | 95.8-98.1 | 97.2 |
| Layer | oxide | | | | |

As a mixed material of zirconium oxide and Ti, OH-5 (trade name; available from K.K. Optron) was used.

### EXPERIMENTAL EXAMPLE 3

A two-layer antireflection coating having the thickness indicated in (2) in Table 1 was formed on S1 of an objective lens identical to the one in Experimental Example 1, and a 7-layer antireflection coating having the thickness indicated in (10) in Table 1 was formed on S2.

Table 5 shows the specifications of the two layers on S1. Note that the specifications of the seven layers on S2 are the same as those shown in Table 4.

TABLE 5

| | | | | | More |
|---|---|---|---|---|---|
| | | | Design | | Preferable |
| | | Refractive | Wavelength | Thickness | Thickness |
| | Material | Index | (nm) | (nm) | (nm) |
| First | tantalum | 1.90-2.01 | 500 | 16-32 | 21.9 |
| Layer | oxide | | | | |
| Second | silicon | 1.45-1.47 | 500 | 85-115 | 112 |
| Layer | oxide | | | | |

### EXPERIMENTAL EXAMPLE 4

A three-layer antireflection coating having the thickness indicated in (4) in Table 1 was formed on S1 of an objective lens identical to the one in Experimental Example 1, and a five-layer antireflection coating having the thickness indicated in (7) in Table 1 was formed on S2.

Table 6 shows the specifications of the three layers on S1. Table 7 shows the specifications of the five layers on S2.

TABLE 6

| | | | | | More |
|---|---|---|---|---|---|
| | | | Design | | Preferable |
| | | Refractive | Wavelength | Thickness | Thickness |
| | Material | Index | (nm) | (nm) | (nm) |
| First | aluminum | 1.55-1.70 | 500 | 63-94 | 74.7 |
| Layer | oxide | | | | |
| Second | tantalum | 1.90-2.01 | 500 | 100-150 | 124.6 |
| Layer | oxide | | | | |
| Third | silicon | 1.45-1.47 | 500 | 68-100 | 85.5 |
| Layer | oxide | | | | |

TABLE 7

| | | | | | More |
|---|---|---|---|---|---|
| | | | Design | | Preferable |
| | | Refractive | Wavelength | Thickness | Thickness |
| | Material | Index | (nm) | (nm) | (nm) |
| First | silicon | 1.45-1.47 | 500 | 150-170 | 164.2 |
| Layer | oxide | | | | |
| Second | OH-5 | 1.94-2.02 | 500 | 11-14 | 12.2 |
| Layer | | | | | |
| Third | silicon | 1.45-1.47 | 500 | 25-29 | 27.9 |
| Layer | oxide | | | | |
| Fourth | OH-5 | 1.94-2.02 | 500 | 110-120 | 116.7 |
| Layer | | | | | |
| Fifth | silicon | 1.45-1.47 | 500 | 80-90 | 84.2 |
| Layer | oxide | | | | |

### EXPERIMENTAL EXAMPLE 5

A four-layer antireflection coating having the thickness indicated in (5) in Table 1 was formed on S1 of an objective lens identical to the one in Experimental Example 1, and a five-layer antireflection coating having the thickness indicated in (8) in Table 1 was formed on S2.

Table 8 shows the specifications of the four layers on S1. Note that the specifications of the five layers on S2 are the same as those shown in Table 4.

TABLE 8

| | | | | | More |
|---|---|---|---|---|---|
| | | | Design | | preferable |
| | | Refractive | Wavelength | Thickness | Thickness |
| | Material | Index | (nm) | (nm) | (nm) |
| First | silicon | 1.45-1.47 | 500 | 165-175 | 170.8 |
| Layer | oxide | | | | |
| Second | OH-5 | 1.94-2.02 | 500 | 50-68 | 60.4 |
| Layer | | | | | |
| Third | OA-600 | 1.95-2.01 | 500 | 50-60 | 53.0 |
| Layer | | | | | |
| Fourth | silicon | 1.45-1.47 | 500 | 80-90 | 85.5 |
| Layer | oxide | | | | |

### EXPERIMENTAL EXAMPLE 6

A five-layer antireflection coating having the thickness indicated in (8) in Table 1 was formed on S1 of an objective lens identical to the one in Experimental Example 1, and a seven-layer antireflection coating having the thickness indicated in (10) in Table 1 was formed on S2.

Table 9 shows the specifications of the five layers on S1. The specifications of the seven layers on S2 are the same as those shown in Table 4.

TABLE 9

| | | | | | More |
|---|---|---|---|---|---|
| | | | Design | | Preferable |
| | | Refractive | Wavelength | Thickness | Thickness |
| | Material | Index | (nm) | (nm) | (nm) |
| First | aluminum | 1.55-1.70 | 520 | 25-35 | 31.1 |
| Layer | oxide | | | | |
| Second | silicon | 1.45-1.47 | 520 | 40-45 | 42.7 |
| Layer | oxide | | | | |
| Third | aluminum | 1.55-1.70 | 520 | 95-100 | 99.5 |
| Layer | oxide | | | | |
| Fourth | OH-5 | 1.95-2.01 | 520 | 120-130 | 126.0 |
| Layer | | | | | |
| Fifth | silicon | 1.45-1.47 | 520 | 80-95 | 89.0 |
| Layer | oxide | | | | |

### EXPERIMENTAL EXAMPLE 7

A six-layer antireflection coating having the thickness indicated in (9) in Table 1 was formed on S1 of an objective lens identical to the one in Experimental Example 1, and a seven-layer antireflection coating having the thickness indicated in (10) in Table 1 was formed on S2.

Table 10 shows the specifications of the six layers on S1. The specifications of the seven layers on S2 are the same as those shown in Table 2.

TABLE 10

| | | | | | More |
|---|---|---|---|---|---|
| | | | Design | | Preferable |
| | | Refractive | Wavelength | Thickness | Thickness |
| | Material | Index | (nm) | (nm) | (nm) |
| First | silicon | 1.45-1.47 | 500 | 15-20 | 17.1 |
| Layer | oxide | | | | |
| Second | aluminum | 1.55-1.70 | 500 | 24-30 | 29.9 |
| Layer | oxide | | | | |
| Third | silicon | 1.45-1.47 | 500 | 35-40 | 37.6 |
| Layer | oxide | | | | |
| Fourth | aluminum | 1.55-1.70 | 500 | 85-91 | 89.7 |
| Layer | oxide | | | | |
| Fifth | OH-5 | 1.95-2.01 | 500 | 118-123 | 120.9 |
| Layer | | | | | |
| Sixth | silicon | 1.45-1.47 | 500 | 86-93 | 88.7 |
| Layer | oxide | | | | |

### EXPERIMENTAL EXAMPLE 8

A seven-layer antireflection coating was formed on S1 of the objective lens made of Zeonex resin in the shape shown in FIG. 3 through which three types of light beams of wavelengths of 405 nm, 650 nm, and 780 nm pass, and a 10-layer antireflection coating having the thickness indicated by (14) in Table 1 was formed on S2.

Table 11 shows the specifications of the seven layers on S1. Table 12 shows the specifications of the 10 layers on S2.

TABLE 11

| | | | | | More |
|---|---|---|---|---|---|
| | | | Design | | Preferable |
| | | Refractive | Wavelength | Thickness | Thickness |
| | Material | Index | (nm) | (nm) | (nm) |
| First | silicon | 1.45-1.47 | 480 | 115-129 | 121.3 |
| Layer | oxide | | | | |
| Second | zirconium | 1.8-2.2 | 480 | 14-20 | 16.1 |
| Layer | oxide | | | | |
| Third | silicon | 1.45-1.47 | 480 | 37-48 | 42.1 |
| Layer | oxide | | | | |
| Fourth | zirconium | 1.8-2.2 | 480 | 58-67 | 63.1 |
| Layer | oxide | | | | |
| Fifth | silicon | 1.45-1.47 | 480 | 12-17 | 15.0 |
| Layer | oxide | | | | |
| Sixth | zirconium | 1.8-2.2 | 480 | 47-55 | 51.3 |
| Layer | oxide | | | | |
| Seventh | silicon | 1.45-1.47 | 480 | 94-109 | 101.1 |
| Layer | oxide | | | | |

TABLE 12

| | | | | | More |
|---|---|---|---|---|---|
| | | | Design | | Preferable |
| | | Refractive | Wavelength | Thickness | Thickness |
| | Material | Index | (nm) | (nm) | (nm) |
| First | zirconium | 1.8-2.2 | 530 | 24-30 | 26.8 |
| Layer | oxide | | | | |
| Second | silicon | 1.45-1.47 | 530 | 19-24 | 22.2 |
| Layer | oxide | | | | |
| Third | zirconium | 1.8-2.2 | 530 | 50-58 | 52.9 |
| Layer | oxide | | | | |
| Fourth | silicon | 1.45-1.47 | 530 | 41-49 | 45.1 |
| Layer | oxide | | | | |
| Fifth | zirconium | 1.8-2.2 | 530 | 19-25 | 22.4 |
| Layer | oxide | | | | |
| Sixth | silicon | 1.45-1.47 | 530 | 174-199 | 187.6 |
| Layer | oxide | | | | |
| Seventh | zirconium | 1.8-2.2 | 530 | 67-78 | 72.8 |
| Layer | oxide | | | | |
| Eighth | silicon | 1.45-1.47 | 530 | 17.9-18 | 16.4 |
| Layer | oxide | | | | |
| Ninth | zirconium | 1.8-2.2 | 530 | 33-41 | 37.9 |
| Layer | oxide | | | | |
| 10th Layer | silicon | 1.45-1.47 | 530 | 93-106 | 99.5 |
| | oxide | | | | |

An underlayer which is made of silicon oxide and has a thickness of 0.2μ to 2μ may be provided between the base material and the first layer of the 10-layer antireflection coating on S2.

### EXPERIMENTAL EXAMPLE 9

A seven-layer antireflection coating was formed on S1 of the objective lens made of Zeonex resin in the shape shown in FIG. 4 through which three types of light beams of wavelengths of 405 nm, 650 nm, and 780 nm pass, a seven-layer antireflection coating having the thickness indicated in (11) in Table 1 was formed on S2, a 10-layer antireflection coating having the thickness indicated by (14) in Table 1 was formed on S3, and a 10-layer antireflection coating having the thickness indicated by (14) in Table 1 was formed on S4.

Table 13 shows the specifications of the seven layers on each of S

1 and S2. Note that the specifications of the 10 layers on each of S3 and S4 are the same as those shown in Table 12.

TABLE 13

| | | | | | More |
|---|---|---|---|---|---|
| | | | Design | | Preferable |
| | | Refractive | Wavelength | Thickness | Thickness |
| | Material | Index | (nm) | (nm) | (nm) |
| First | silicon | 1.45-1.47 | 480 | 115-129 | 121.7 |
| Layer | oxide | | | | |
| Second | hafnium | 1.7-2.2 | 480 | 12-20 | 16.2 |
| Layer | oxide | | | | |
| Third | silicon | 1.45-1.47 | 480 | 37-48 | 42.3 |
| Layer | oxide | | | | |
| Fourth | hafnium | 1.7-2.2 | 480 | 58-68 | 62.9 |
| Layer | oxide | | | | |
| Fifth | silicon | 1.45-1.47 | 480 | 12-17 | 15.0 |
| Layer | oxide | | | | |
| Sixth | hafnium | 1.7-2.2 | 480 | 47-56 | 51.0 |
| Layer | oxide | | | | |
| Seventh | silicon | 1.45-1.47 | 480 | 95-109 | 103.0 |
| Layer | oxide | | | | |

### COMPARATIVE EXPERIMENTAL EXAMPLE 1

A seven-layer antireflection coating with specifications similar to those in Table 2 (Experimental Example 1) was formed on S1 of an objective lens identical to the one in Experimental Example 1, and a seven-layer antireflection coating with specifications similar to those in Table 4 (Experimental Example 2) was formed on S2.

### COMPARATIVE EXPERIMENTAL EXAMPLE 2

A 10-layer antireflection coating with specifications similar to those in Table 12 (Experimental Example 9) was formed on each of S1 and S2 of an objective lens identical to the one in Experimental Example 9, and a seven-layer antireflection coating with specifications similar to those in Table 11 (Experimental Example 8) was formed on each of S3 and S4.

Light condensing characteristics, the amounts of light transmitted, and wiping resistance (the peeling resistance of each film which was obtained when a swab impregnated with isopropyl alcohol was slid on S1 of each lens while being pressed on it with a load of 10 g), which indicated the degrees of deterioration in diffraction structures, were evaluated with respect to Experimental Examples 1 to 9 and Comparative Experimental Examples 1 and 2 described above under the same conditions. Tables 14 and 15 show evaluation results and evaluation criteria.

TABLE 14

| | Light | Amount | |
|---|---|---|---|
| | Condens- | Of | |
| | ing | Light | Wiping |
| | Character- | Trans- | Resis- |
| | istics | mitted | tance |
| Experimental Example 1 | ◯ | Δ | — |
| Experimental Example 2 | ◯ | Δ | ◯ |
| Experimental Example 3 | ◯ | ◯ | ◯ |
| Experimental Example 4 | ◯ | ◯ | ◯ |
| Experimental Example 5 | ◯ | ◯ | ◯ |
| Experimental Example 6 | Δ | ◯ | Δ |
| Experimental Example 7 | Δ | ◯ | Δ |
| Experimental Example 8 | Δ | ◯ | Δ |
| Experimental Example 9 | Δ | ◯ | Δ |
| Comparative | X | ◯ | X |
| Experimental Example 1 | | | |
| Comparative | X | ◯ | X |
| Experimental Example 2 | | | |

TABLE 15

| | ◯ (level at | | |
|---|---|---|---|
| | which no | Δ (level at | |
| | practical | which no | X (level at |
| | problem | practical | which some |
| | occurs at | problem | problem |
| | all) | occurs) | occurs) |
| Light | information | information | crosstalk |
| Condensing | can be | can be | occurs and |
| Characteris- | properly | properly | information |
| tics | reproduced by | reproduced by | cannot be |
| | optical | optical | stably repro- |
| | pickup | pickup | duced |
| | apparatus | apparatus | |
| | without any | without any | |
| | crosstalk | crosstalk | |
| Amount of | lens | lens | lens |
| Light | transmittance | transmittance | transmittance |
| Transmitted | is 90% or | is 85% or | is less than |
| | more with | more with | 85% with |
| | respect to | respect to | respect to |
| | laser beam to | laser beam to | laser beam to |
| | be used | be used (no | be used (some |
| | (excellent | practical | practical |
| | transmittance) | problem | problem |
| | | occurs) | occurs) |
| Wiping | no peeling | no peeling | peeling |
| Resistance | occurs after | occurs after | occurs after |
| | 50 times of | 20 times of | 20 times of |
| | wiping | wiping | wiping |

As indicated by Table 14, with regard to an objective lens in the shape shown in FIG. 3, it was understood that the light condensing and wiping resistance characteristics in Comparative Experimental Example 1 could not meet the required level, whereas the light condensing and wiping resistance characteristics and the amounts of light transmitted in Experimental Examples 1 to 8 met the required levels. In addition, with regard to an objective lens in the shape shown in FIG. 4, it was found that the light condensing and wiping resistance characteristics in Comparative Experimental Example 2 could not meet the required level, whereas the light condensing and wiping resistance characteristics and the amount of light transmitted in Experimental Example 9 met the required levels.

The present invention has been described with reference to several embodiments and the above plurality of experimental examples. Obviously, however, the present invention should not be interpreted as limited to the above embodiments and experimental examples, and can be modified and improved as needed.

1. An optical component comprising:
a first optical surface having a fine structure;
a second optical surface without having the fine structure;
a first antireflection film provided on the first optical surface, in which the first antireflection film includes at least one layer; and
a second antireflection film provided on the second optical surface, in which the second antireflection film includes a plurality of layers,
wherein the number of layers of the first antireflection film is less than the number of layers of the second antireflection film.

2. The optical component of claim 1, wherein the fine structure is a ring-like phase-difference-generating structure.

3. The optical component of claim 1, wherein the second antireflection film consists of seven layers.

4. The optical component of claim 1, wherein the second antireflection film consists of eight layers to ten layers.

5. The optical component of claim 1, wherein the first antireflection film consists of one layer.

6. The optical component of claim 1, wherein the first antireflection film consists of two layers.

7. The optical component of claim 1, wherein the first antireflection film consists of three layers.

8. The optical component of claim 1, wherein the first antireflection film consists of four layers to nine layers.

9. An optical component comprising:
a first optical surface having a fine structure;
a second optical surface without having the fine structure; and
an antireflection film provided only on the second optical surface.

10. The optical component of claim 9, wherein the fine structure is a ring-like phase-difference-generating structure.

11. The optical component of claim 9, wherein the antireflection film consists of seven layers.

12. The optical component of claim 9, wherein the antireflection film consists of eight layers to ten layers.

13. The optical component of claim 1, wherein the optical component is an objective lens for use in an optical pickup apparatus.

14. The optical component of claim 9, wherein the optical component is an objective lens for use in an optical pickup apparatus.

15. The optical component of claim 13, wherein said objective lens is capable of condensing each of light beams of different wavelengths emitted from a plurality of light sources mounted in the optical pickup apparatus, onto an information recording surface of optical information recording media corresponding to each of the light beams.

16. The optical component of claim 14, wherein said objective lens is capable of condensing each of light beams of different wavelengths emitted from a plurality of light sources mounted in the optical pickup apparatus, onto an information recording surface of optical information recording media corresponding to each of the light beams.

17. The optical component of claim 13, wherein the objective lens is capable of condensing a light beam of a wavelength λ (λ<450 nm) onto an information recording surface of an optical information recording medium.

18. The optical component of claim 14, wherein the objective lens is capable of condensing a light beam of a wavelength λ (λ<450 nm) onto an information recording surface of an optical information recording medium.

19. An optical component for use in an optical pickup apparatus, comprising:
a plurality of optical surfaces;
a first antireflection film provided on one optical surface of the optical surfaces, in which the first antireflection film includes at least one layer; and
a second antireflection film provided on the other optical surface of the optical surface, in which the second antireflection film includes a plurality of layers,
wherein the optical component is arranged on an optical path through which a first light beam of a wavelength λ1 (390 nm≦λ1≦450 nm) passes, and at least one of a second light beam of a wavelength λ2 (635 nm≦λ2≦670 nm) and a third light beam of a wavelength λ3 (740 nm≦λ3≦810 nm) passes in the optical pickup apparatus, and the following conditional formula is satisfied: m1<m2 wherein m1 is the number of layers of the first anti-reflection film, and m2 is the number of layers of the second antireflection film.

20. The optical component of claim 19, wherein a phase-difference-generating structure is formed on the one optical surface.

21. The optical component of claim 19, wherein the following conditional formula is satisfied: Φ1>Φ2 where Φ1 is an effective diameter of the one optical surface when the first light beam passes through the optical component, and Φ2 is an effective diameter of the other optical surface when the first light beam passes through the optical component.

22. The optical component of claim 19, wherein the number of layers m2 is seven.

23. The optical component of claims 19, wherein the number of layers m2 is eight to ten.

24. An optical pickup apparatus comprising a light source and a condensing optical system including the optical component of claim 1, wherein the optical component is capable of condensing a light beam from a light source onto an information recording surface of an optical information recording medium.

25. An optical pickup apparatus comprising a light source and a condensing optical system including the optical component of claim 9, wherein the optical component is capable of condensing a light beam from a light source onto an information recording surface of an optical information recording medium.

26. An optical pickup apparatus comprising a plurality of light sources and a condensing optical system including the optical component of claim 19, wherein the optical component is capable of condensing each of light beams from the light sources onto information recording surfaces of optical information recording media corresponding to each of the light beams, respectively.
